(19) United States
(12) Patent Application Publication
(10) Pub. No.: US 2006/0028787 A1
(43) Pub. Date: Feb. 9, 2006

(54) Wet electrolytic capacitor

(76) Inventors: Katsuhiro Yoshida, Miyagi (JP); Yoshihiko Saiki, Miyagi (JP); Hiroyuki Kamisuki, Miyagi (JP); Masahiro Murata, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/199,038

(22) Filed: Aug. 8, 2005

(30) Foreign Application Priority Data
Aug. 9, 2004 (JP) 2004-232150

(51) Int. Cl. H01G 9/00

(52) U.S. Cl. 361/523

(57) ABSTRACT

The electrolytic capacitor and the electric double-layer capacitor both have difficulties to satisfy recent demands that the capacitor should have lower resistance, larger capacitance and moreover smaller size and thinner film thickness, altogether. The present invention provides a wet electrolytic capacitor which comprises a porous anode substance wherein at least a surface of a porous material made of a powder of a valve metal is an oxide film of the valve metal, a cathode formed of either an active carbon layer or a porous material made of a powder of a valve metal and an acid electrolytic solution contained between the porous anode substance and the cathode electrode.

### BACKGROUND OF THE INVENTION

1. Field of the invention

The present invention relates to a wet electrolytic capacitor, and more particularly to a wet electrolytic capacitor having an anode wherein a valve metal is utilized for a porous anode substance.

2. Description of the Related Art

FIG. 5(a) is a schematic view showing the structure of a wound type aluminium electrolytic capacitor.

FIG. 5(b) is an exploded view of the wound type aluminium electrolytic capacitor. In structure, the wound type aluminium electrolytic capacitor has a capacitor element 16 of wound layers comprising an anode foil 14 and a cathode foil 13, separated by a layer of a separator 15, which is, together with an electrolytic solution 17, inserted into a metal case 18 and sealed with a sealing rubber.

The anode foil 14 is made of a metallic aluminium foil and on its surface, an oxide film is formed as a dielectric. Since the electrostatic capacitance of the capacitor is proportional to its electrode area, the surface of the metallic aluminium foil is, prior to the formation of the dielectric film, roughened or subjected to a chemical conversion to increase its effective area. Generally, this step of roughening the surface of the metallic aluminium foil is called etching. The etching is normally carried out either by the method (chemical etching) of conducting immersion into a solution of hydrochloric acid or by the method (electrochemical etching) of carrying out electrolysis in an aqueous solution of hydrochloric acid with aluminium acting as the anode. After the surface is roughened by means of etching, the aluminium surface is, in part, subjected to chemical conversion (anodization) into an oxide film to become a dielectric. FIG. 5(c) is an expanded cross-sectional view of the anode foil 14.

The chemical conversion, wherein an oxide film that is electrically an insulator is formed on the surface of aluminium, is performed with a positive voltage being applied thereto, within an electrolytic solution used for chemical conversion, for instance, ammonium borate, ammonium phosphate or ammonium adipate.

The separator 15, made of a special paper, has functions of preventing contact between the anode foil 13 and the cathode foil 14 being made, being impregnated with an electrolytic solution to keep it in place and enabling ions in the electrolytic solution to move between the electrodes (See Japanese Patent Application laid-open No. 13289/1993 and Japanese Patent Application laid-open No. 120092/1994).

The capacitance of the aluminium electrolytic capacitor is determined by the extent of roughing (the surface area) of the anode foil 13 and the thickness and the dielectric constant of the oxide film 19. Nevertheless, the dielectric constant of aluminium oxide is lower than any of the dielectric constants of tantalum oxide, niobium oxide and the like which are used, respectively, in the electrolytic capacitors such as the tantalum electrolytic capacitor and the niobium electrolytic capacitor, and, consequently, for a given capacitance, the aluminium electrolytic capacitor has disadvantageously a larger size than the tantalum electrolytic capacitor or niobium electrolytic capacitor. Furthermore, because the anode foil 13, the separator 15 and the cathode foil 14 are all wound together as layers, the widths of the foils are difficult to reduce, causing another disadvantage that the height (the thickness) of the products cannot be made satisfactorily small. Although another structure of layered foils than wound type one has been currently proposed, the aluminium electrolytic capacitor itself is not well suited for application to the products in small size, since, due to a low dielectric constant of aluminium oxide, it can attain a large capacitance only through an increase in number of layers.

Meanwhile, accompanying recent increases in capacitance and speed in the field of information technology, there have arisen strong demands that still lower resistances and still larger capacitances as well as reductions in size and film thickness should be brought about in the power supply system. Now, the electrical resistance of the capacitor is generally expressed by the equivalent series resistance (ESR).

In the case of the aluminium electrolytic capacitor, as the aluminium oxide film formed on the anode foil is the dielectric, the electrolytic solution which makes direct contact with the dielectric effectively functions as the cathode. Because aluminium is liable to react with acid, such an electrolytic solution with a low electrical resistance such as sulfuric acid cannot be used herein, and this difficulty in lowering the ESR harder to satisfy requirements arising in application.

Meanwhile, as a wet capacitor capable to have a thin product form and a considerably large capacitance, the electric double-layer capacitor (EDLC) is known. Referring to FIG. 6, the structure of the EDLC is described below.

FIG. 6(a) is an overhead view of a unit cell 100 of an electric double-layer capacitor. The top surface and the under surface of the electric double-layer capacitor are each formed of a current collector 6.

FIG. 6(b) is a cross-sectional view of FIG. 6(a), taken along the line A-A′. A unit cell 100 of an electric double-layer capacitor has, within a gasket 7, layers comprising a pair of active carbon layers 5 which are disposed face to face and are to serve as electrodes, an electrolytic solution of sulfuric acid 3 contained between the pair of active carbon layers 5 and a separator 4 which is formed of acid-proof polymeric fiber to separate the active carbon layers 5 facing each other. In addition, facing each other, current collectors 6 made of conductive rubber are each formed to lie close to an active carbon layer 5 that is to serve as an electrode, whereby an EDLC cell 100 that is a unit cell of an electric double-layer capacitor is constituted.

FIG. 6(c) is a view showing a unit cell 100 of an electric double-layer capacitor on which a terminal plate 10 is formed, and FIG. 6(d) is a side view of FIG. 6(c), taken from the direction of the arrow. After a terminal plate 10 is formed on a unit cell 100 of the electric double-layer capacitor, sealing with a laminate film 9 is applied thereto to finish the product (See Japanese Patent Application laid-open No. 275750/1998 and Japanese Patent Application laid-open No. 199328/1998).

The capacitance per unit volume of the electric double-layer capacitor is determined by the surface area of the active carbon serving as an electrode. In general, the active carbon is a material with a very high surface area having fine holes with diameters ranging from several nm to several tens nm or so. The concurrent application of a positive and a negative voltage between the electrodes leads to formation of electric double layers composed of a thin film in which molecules of the electrolyte lie side by side along the interface of the electrode and, overlying that in the electrolytic solution, a diffusion layer of electrolytic ions attracted by the electrode, and this structure provides a large capacitance. With this structure, a capacitance per unit volume is large enough to produce a capacitor of small size with a high capacitance readily. Moreover, since this structure allows a strong acid with a low electrical resistance such as sulfuric acid to be employed as the electrolytic solution, the ESR may be advantageously lowered with ease. However, its withstand voltage as a capacitor is determined by the electrolysis voltage of the electrolytic solution in use, and, as a result, when an aqueous electrolytic solution with a low electrical resistance such as sulfuric acid is utilized, the withstand voltage may become as low as 0.7 V or so.

The withstand voltage of the electric double-layer capacitor can be raised by overlaying a plurality of unit cells 100 of the electric double-layer capacitor in series and forming a terminal plate 10 each on the top and the under surfaces thereof, as shown in FIG. 7. When unit cells are laid in series, a voltage applied to one EDLC that forms a unit cell is lowered, enabling the withstand voltage to increase. However, this arrangement of layers of a plurality of unit cells in series increases the ESR in proportion to the number of layered cells so that, if the withstand voltage equivalent to that of the aluminium electrolytic capacitor is provided by this arrangement, its ESR becomes greater than that of the aluminium electrolytic capacitor.

In the electrolytic capacitor, opposite electrodes are, in effect, composed of the dielectric formed on one electrode whose surface is roughened and the electrolyte that acts as the effective cathode. In contrast with this, in the electric double-layer capacitor, an application of a positive and a negative voltage between the electrodes leads to formation of electric double layers composed of a thin film in which molecules of the electrolyte lie side by side along the interface of the electrode and, overlying that in the electrolytic solution, a diffusion layer of electrolytic ions attracted by the electrode, and the electricity is stored therein. Although the electrolytic capacitor and the electric double-layer capacitor are based on different principles as the capacitor, their structures resemble a great deal, for instance, the electrolytic solution is impregnated between two opposite electrodes and, furthermore, there is disposed a separator which allows ions of the electrolyte to pass through but prevents two electrodes from making contact so as to avoid short circuit.

However, the electrolytic capacitor and the electric double-layer capacitor, described above, both have difficulties to satisfy recent demands that the capacitor should have lower resistance, larger capacitance and moreover smaller size and thinner film thickness, altogether.

In light of the above problems, an object of the present invention is to provide a capacitor capable to achieve satisfactorily a decrease in resistance and an increase in capacitance as well as reductions in size and film thickness.

### SUMMARY OF THE INVENTION

The present invention relates to a wet electrolytic capacitor which comprises a porous anode substance wherein at least a surface of a porous material made of a powder of a valve metal is an oxide film of said valve metal, a cathode formed of either an active carbon layer or a porous material made of a powder of a valve metal and an acid electrolytic solution contained between said porous anode substance and said cathode electrode. The electrolytic solution is preferably sulfuric acid.

The valve metal is preferably a metal having the resistance against the acid electrolytic solution, and more preferably either tantalum or niobium.

In the present invention, a porous anode substance made of a valve metal is used for an anode and an active carbon layer or a porous cathode substance similar to the one used for the anode is used for a cathode, and a strong acid with a low electrical resistance such as sulfuric acid is utilized as an electrolytic solution and thereby a wet capacitor of a small size (thin type) with a high capacitance as well as a low ESR can be obtained.

### BRIEF DESCRIPTION OF THE DRAWING

FIG. 1 is a schematic view showing the structure of a wet electrolytic capacitor of the present invention.

FIG. 2 is a detailed view showing a porous anode substance.

FIG. 3 is a schematic view showing the structure of another wet electrolytic capacitor of the present invention.

FIG. 4 is a schematic view showing the structure of another wet electrolytic capacitor of the present invention.

FIG. 5 is a schematic view showing a conventional aluminium electrolytic capacitor.

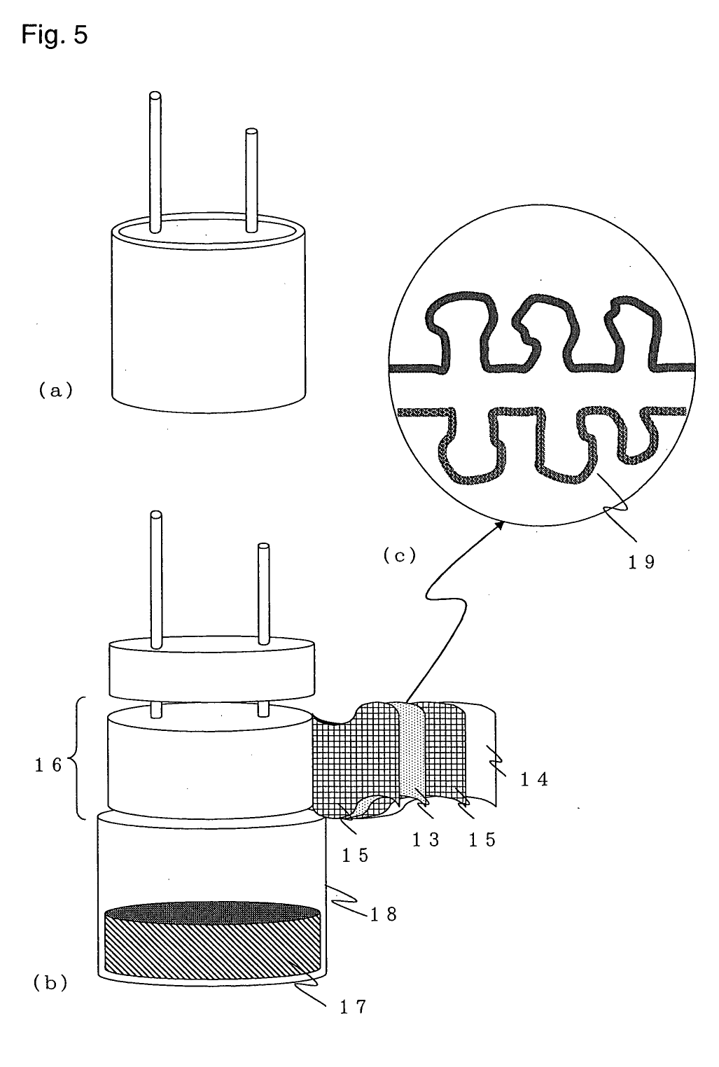

FIG. 6 is a schematic view showing the structure of an electric double-layer capacitor.

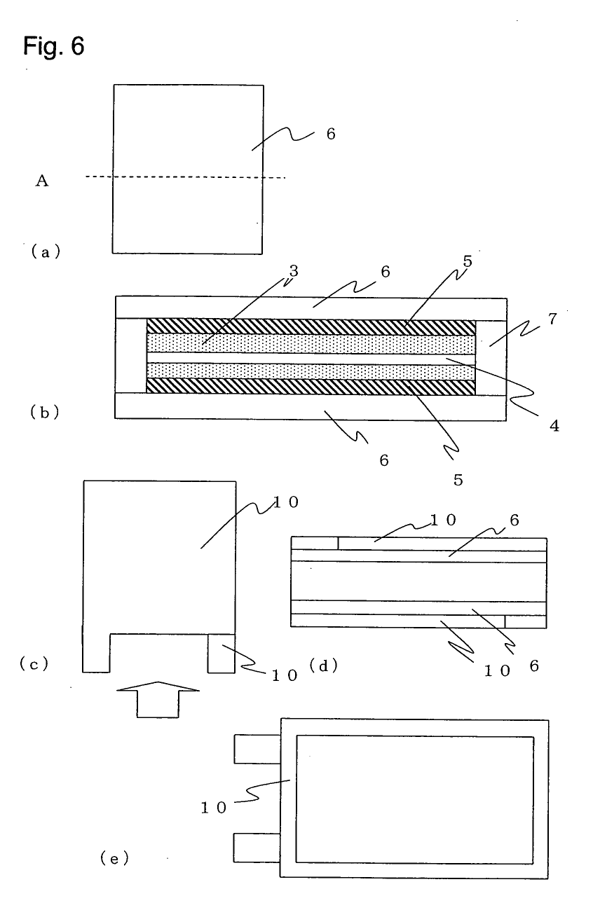

FIG. 7 is a schematic view showing the structure of another electric double-layer capacitor.

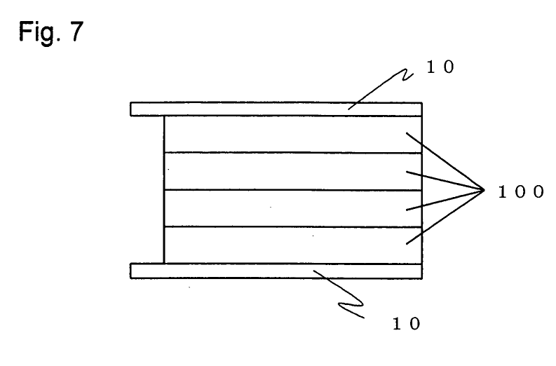

### DETAILED DESCRIPTION OF THE INVENTION AND PREFERRED EMBODIMENTS

The present invention provides an electrolytic capacitor wherein an electrolytic solution is contained between a porous anode substance formed of a porous material on the surface of which a dielectric substance layer is formed and a porous cathode substance formed of a porous material, whereby a larger capacitance and a thinner film (a lower height) are both satisfactorily achieved.

For the porous anode substance made of a porous material on the surface of which a dielectric substance layer is formed, it is preferable that a porous material is formed by sintering a preformed powder of a valve metal such as tantalum, niobium, titanium, hafnium, zirconium or tungsten, and applying anodization thereto, an oxide film is formed on the surface of the porous material.

While sintering of above mentioned preformed powder of a valve metal makes it possible to form a porous material with a large surface area, the anodization enables a dielectric substance layer made of a metal oxide film with a thin film thickness to be formed on the surface of the porous material.

Examples of the electrolytic solution possible to utilize herein include ammonium borate, ammonium phosphate, ammonium adipate and an inorganic electrolytic solution such as sulfuric acid as well as an organic electrolytic solution in which a supporting electrolyte is dissolved in an organic solvent.

Although the electrolytic solution with a low electrical resistance such as sulfuric acid can favorably reduce the ESR, sulfuric acid is a material liable to react with metal. When, subjected to the anodization, the surface of a sintered material of a valve metal such as tantalum or niobium is oxidized to form an oxide film of tantalum or niobium is formed thereon, an oxide film of tantalum or niobium is stable even in a strong acid such as sulfuric acid so that its use causes no problem.

The cathode has preferably a large surface area, and the porous material formed by sintering a valve metal powder perform and the porous material made of active carbon have a large surface area as well as good acid resistance and are well suited for this purpose. As the active carbon, obviously any nanocarbon, for instance, carbon nanotube or carbon nanohorn can be used.

The porous material is formed on a conductive substrate. When the porous material formed by baking a valve metal is used, any metal possible to stand the baking temperature of that particular valve metal can be used as the conductive substrate. On the other hand, when the porous material made of active carbon is used, sintering is unnecessary so that any material can be utilized as long as conductive, and, for instance, a conductive organic resin or a metal can be employed.

Examples of the electrolytic solution possible to utilize herein include ammonium borate, ammonium phosphate, ammonium adipate and an inorganic electrolytic solution such as sulfuric acid as well as an organic electrolytic solution in which a supporting electrolyte is dissolved in an organic solvent.

For the electrolytic solution of the present invention, an electrolytic solution with a low electrical resistance such as sulfuric acid is preferably used because it can reduce the ESR. Even when a corrosive electrolytic solution, for instance, a strong acid such as sulfuric acid or an organic electrolytic solution is used, the porous anode substance wherein an oxide film is formed on the surface of a porous material made of a valve metal with a good acid resistance such as tantalum or niobium, and the porous cathode substance comprising a porous cathode substance and/or active carbon have a good resistance against the electrolyte, no problem arises. Further, the conductive substrate holding the porous anode substance or the porous cathode substance is preferably made of a valve material such as tantalum or niobium, for which a metal oxide film having a good acid resistance is formed on the surface.

Now, referring to the drawings, the embodiments of the present invention are described in detail below.

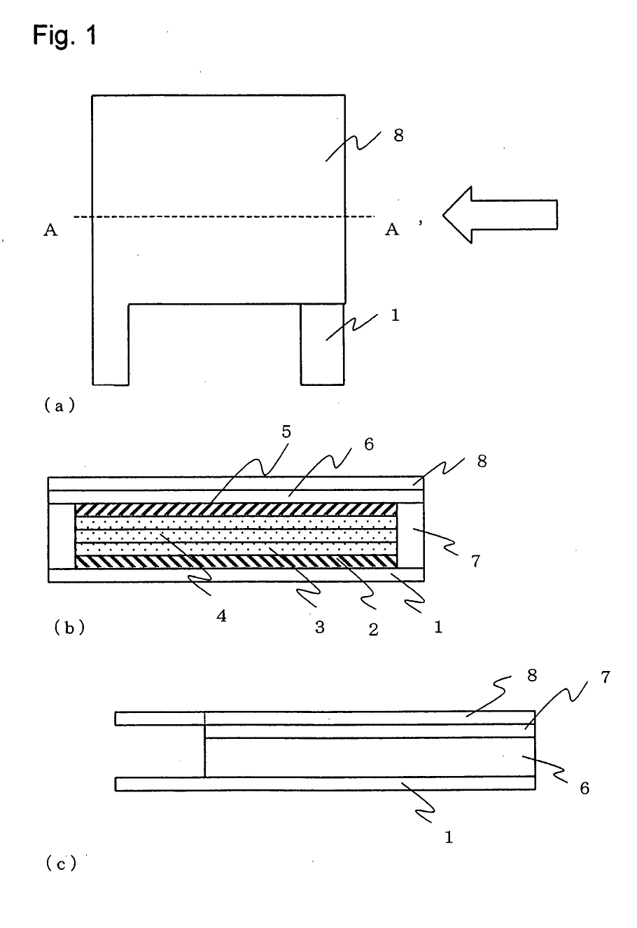

FIG. 1(a) is a top view of an electrolytic capacitor having the standard structure of the first embodiment of the present invention. FIG. 1(b) is a cross-sectional view of FIG. 1(a), taken along the line A-A′. The electrolytic capacitor of the present embodiment has, within a gasket 7, layers comprising a porous anode substance 2 and an active carbon layer 5 which are disposed face to face, and an electrolytic solution 3 and a separator 4 which are contained between the porous anode substance 2 and active carbon layer 5.

The porous anode substance 2 is formed on a thin metal film 1, and adjacent to the active carbon layer 5, a current collector 6 is formed to hold the active carbon layer 5, and adjacent to the current collector 6, a terminal plate 8 is formed on a surface of the current collector 6 which faces its another surface on which the active carbon layer is formed.

FIG. 1(c) is a side view of FIG. 1(a), taken from the direction of the arrow. On the thin metal film 1 and the terminal plate 8, a terminal electrode protruding from the gasket 7 is each formed.

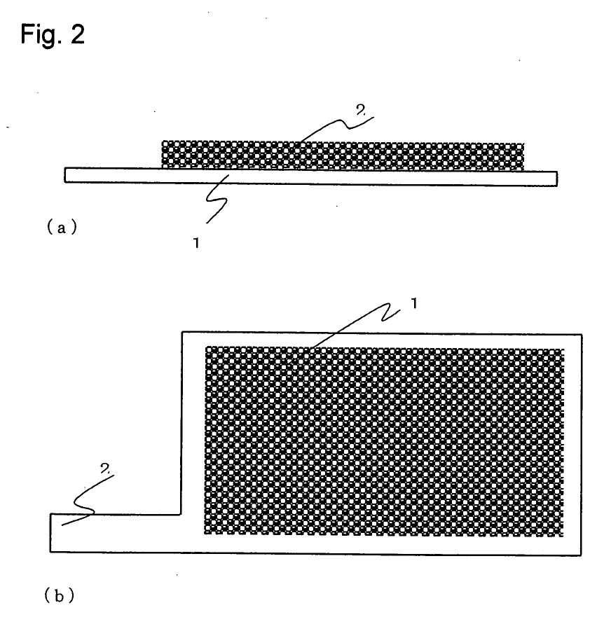

FIG. 2 is a detailed view showing the porous anode substance formed on the thin metal film 1.

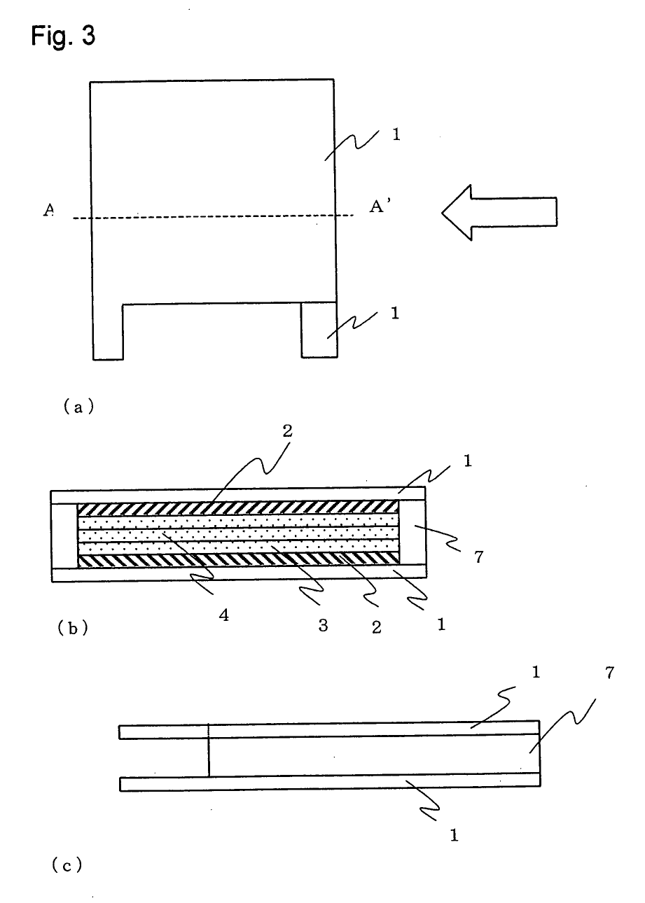

FIG. 3 is a view showing the structure of an electrolytic capacitor of the second embodiment. In the present embodiment, in place of the active carbon layer 5 in the first embodiment, a porous material used for the anode in the first embodiment is utilized. The present embodiment has the same structure as the first embodiment excepting that, in place of the current collector 6 and the terminal plate 8, a thin metal film 1 is used to hold the porous material, resulting from the employment of the porous material.

### EXAMPLES

### First Example

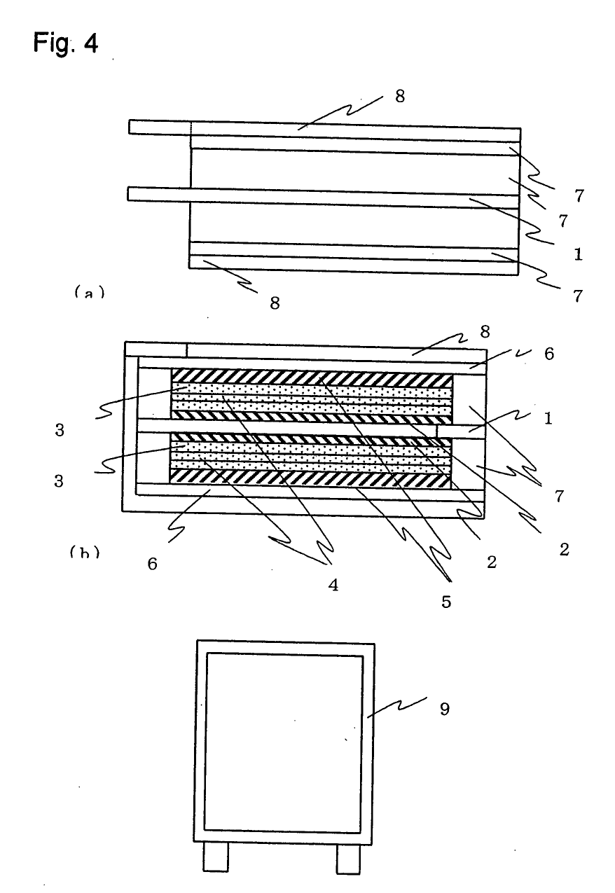

Referring to FIG. 4, the structure of the First Example of the present invention is described below. FIG. 4(a) is a schematic side view of First Example. Within a gasket 7 formed over both surfaces of the thin metal film 1, there are formed a porous anode substance 2 on the thin metal film, an active carbon layer 5 disposed to face that, and an electrolytic solution 3 and a separator 4, both of which are contained between the porous anode substance 2 and active carbon layer 5 opposite. An anode terminal is formed on the thin metal film, protruding.

Adjacent to each active carbon layers 5 a current collector 6 is formed within the gasket 7. On a cathode plate 8 which is formed to cover, together both current collectors 6 formed on opposite faces of the porous anode substrates 2 formed on both faces of the thin metal film, there is formed a cathode electrode.

The structure of the present example in which two capacitors are connected in parallel has, for the same area, the effect of doubling the capacitance of the electrolytic capacitors described in the first and second embodiments. Although a case wherein two capacitors are connected in parallel is given in the present example, it is evident that two or more capacitors can be readily formed in parallel by arranging layers of capacitors in similar fashion without changing the area of the bottom face. In the present example, the height of a unit capacitor constituting the electrolytic capacitor can be made to be 0.3 mm or less, and an arrangement of this sort does not hinder to achieve a thin type capacitor.

In the present example, to form the porous anode substance 2, after a paste of niobium powder was first applied to a thickness of 0.25±0.05 mm, by the printing method onto both surfaces of a metal thin film of niobium 34 mm long by 22 mm wide by 0.1 mm thick, sintering at 1000° C. in a vacuum of about 6.7×10⁻³ Pa (50 pTorr) was carried out for 30 minutes and thereby a metal porous material of niobium was made. As for the paste of niobium powder, niobium powder with a specific surface area of 7 m²/g, 2-2 butoxyethanol (manufactured by Junsei Chemical Co. Ltd., referred to as BC hereinafter) as a dispersing agent, an acrylic resin based binder as a binder and butyl phthanol butyl glycolate (manufactured by Wako Pure Chemical Industries, Ltd., referred to as BPBG hereinafter) as a plasticizer were weighed and mixed so that their contents by weight in the paste of niobium powder might become 70 wt. %, 18 wt. %, 6 wt. % and 6 wt. %, respectively.

Next, performing the anodization of the metal porous material of niobium in 40 wt. % sulfuric acid with a voltage of 8 V being applied for 6 hours, an oxide film with a thickness of 22 nm was formed on the surface of the metal porous material of niobium and the metal thin film of niobium, and thereby a porous anode substance of niobium 2 was obtained.

With respect to the active carbon layer 5 on the cathode side, polyolefin based resin, active carbon powder with a specific surface area of 1200 m²/g, which is on the market, and dimethylformaldehyde were mixed in the weight proportion of 24:2:74 and this mixture was applied to a thickness of 20±5 μm on the current collector 6 by the printing method. After that, drying was carried out at 70° C. for 30 minutes to obtain the active carbon layer 5.

For the gasket 7 and the current collectors 6, butyl rubber based resin was used. In the case of the current collector 6, carbon fiber was mixed into the butyl rubber based resin material to provide the conductivity and this mixed material with a resistivity of 12 Ω cm was grown to a film of 0.1 mm thickness. As the electrolyte 3 and the separator 4, 40 wt. % sulfuric acid and a film of polyolefin based resin with a thickness of 10 μm were utilized, respectively.

Finally, after the current collectors 6 were by means of the pressure welding inserted into the cathode plate 8 made of copper, the whole structure except terminal sections that are to serve as the anode and the cathode was sealed with a laminate film, and thereby a laminate type capacitor, 38.5 mm×26.5 mm×1 mm in dimensions, having a rated voltage of 4 V, a capacitance of 10 mF and an ESR of 25 mΩ was produced.

### Second Example

Another example having the same structure as First Example but utilizing tantalum as a valve metal is described below.

With respect to a tantalum porous anode substance, after a paste of tantalum powder was first applied to a thickness of 0.25±0.05 mm, by the printing method onto both surfaces of a metal thin film of tantalum 34 mm long by 22 mm wide by 0.1 mm thick, sintering at 1100° C. in a vacuum of about 6.7×10⁻³ Pa (50 pTorr) was carried out for 30 minutes and thereby a metal porous material of tantalum was made. As for the paste of tantalum powder, tantalum powder with a specific surface area of 3.5 m²/g, BC as a dispersing agent, an acrylic resin based binder as a binder and BPBG as a plasticizer were weighed and mixed so that their contents by weight in the paste of tantalum powder might become 81 wt. %, 11 wt. %, 4 wt. % and 4 wt. %, respectively.

In this way, a laminate type tantalum capacitor, 38.5 mm×26.5 mm×1 mm in dimensions, having a rated voltage of 4 V, a capacitance of 10 mF and an ESR of 25 mΩ was obtained.

### Third Example

The same structure and the same manufacturing method as First Example were used herein, excepting that an electrode made of an active carbon layer on the cathode side in First Example was replaced by a porous cathode substance made of a sintered material of niobium which was used for the anode in First Example (only differing in a point that no oxide film was formed herein).

The sintered material of niobium has a smaller electrical resistance than the active carbon layer but the resistance component which effectively contributes to the ESR comes from the electrolytic solution so that the change of the cathode from the active carbon electrode to the metal electrode does not affect the ESR much.

Characteristics of an aluminium electrolytic capacitor, an electric double-layer capacitor and capacitors of the present examples, all having the same rated voltage, are listed in Table 1.

TABLE 1

| | Capacitance | Product | Product | ESR |
|---|---|---|---|---|
| | (mF) | Volume | Height | (mΩ) |
| | (at 120 Hz) | (cc) | (mm) | (at 100 kHz) |
| Aluminium electrolytic | 8 | 5.1 | 5.0* | 30 |
| capacitor | | | | |
| EDLC | 47 | 2.0 | 2.0 | 120 |
| First Example | 10 | 1.0 | 1.0 | 25 |
| Second Example | 10 | 1.0 | 1.0 | 25 |
| Third Example | 10 | 1.0 | 1.0 | 22 |

*Note:
The product height of the aluminium electrolytic capacitor is the height calculated from its actual product volume and the area of First Example. The actual product height of the aluminium electrolytic capacitor is 20 mm.

Variations and modifications are possible without departing from the spirit of the invention, and portions of the improvement can be used without others.

1. A wet electrolytic capacitor which comprises a porous anode substance wherein at least a surface of a porous material made of a powder of a valve metal is an oxide film of said valve metal, a cathode formed of either an active carbon layer or a porous material made of a powder of a valve metal and an electrolytic solution contained between said porous anode substance and said cathode electrode.

2. A wet electrolytic capacitor according to claim 1, wherein said electrolytic solution is sulfuric acid.

3. A wet electrolytic capacitor according to claim 2, wherein each of said porous cathode substance and said porous anode substance is a porous substance made of a powder of a valve metal whose surface is an oxide film of said valve metal with a resistance against said sulfuric acid.

4. A wet electrolytic capacitor according to one of claims 3, wherein said valve metal is tantalum or niobium.

5. A wet electrolytic capacitor according to claim 1, which further comprises a housing having, at least, a pair of open ends, wherein said porous anode substance formed on a first conductive substrate is fit into one of these ends, and said porous cathode substance formed on a second conductive substrate is fit into the other end, and in said housing, said porous anode substance and said porous cathode substance are disposed to face each other.

6. A wet electrolytic capacitor according to claim 5, wherein said electrolytic solution is sulfuric acid.

7. A wet electrolytic capacitor according to claim 6, wherein each of said porous cathode substance and said porous anode substance is a porous substance made of a powder of a valve metal whose surface is an oxide film of said valve metal with a resistance against said sulfuric acid.

8. A wet electrolytic capacitor according to claim 7, wherein said valve metal is tantalum or niobium.

9. A wet electrolytic capacitor comprising:
a porous anode comprised of a valve metal material covered with a valve metal oxide film;
a porous cathode comprised of a carbon material or a valve metal material covered with a valve metal oxide film; and
an electrolytic solution contained between and in contact with the porous anode and the porous cathode.

10. The wet electrolytic capacitor according to claim 9, wherein the electrolytic solution is selected from the group consisting of ammonium borate, ammonium phosphate, ammonium adipate, and sulfuric acid.

11. The wet electrolytic capacitor according to claim 9, further comprising a separator between the porous anode and the porous cathode.

12. The wet electrolytic capacitor according to claims 9, wherein the porous anode is a sintered material of a valve metal selected from the group consisting of tantalum, niobium, titanium, hafnium, zirconium, and tungsten.

13. The wet electrolytic capacitor according to claims 9, wherein the valve metal oxide film is an anodized oxide film of a valve metal which is the same as that used in the valve metal material.

14. The wet electrolytic capacitor according to claims 9, wherein the porous anode and the porous cathode are constituted by the same material.
